(19) United States
(12) Patent Application Publication
(10) Pub. No.: US 2009/0018859 A1
(43) Pub. Date: Jan. 15, 2009

(54) Method for vehicle repair estimate and scheduling

(76) Inventors: Jonathan P. Purifoy, Chicago, IL (US); Keith A. Sena, Canton, MI (US); Jon Kemp, Middletown, DE (US); Keith Curley, Hudson, OH (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/895,708

(22) Filed: Aug. 27, 2007

Related U.S. Application Data
(60) Provisional application No. 60/841,856, filed on Sep. 1, 2006.

(51) Int. Cl. G06Q 10/00; G06F 17/30

(52) U.S. Cl. 705/1; 707/104.1; 707/E17.044

(57) ABSTRACT

The present invention is directed to a method for producing a repair estimate and scheduling for repairing a vehicle having one or more defects using a portable computing device. The invention is also directed to a system for producing such estimate and scheduling.

### CROSS-REFERENCE TO RELATED APPLICATION

This application claims priority under 35 U.S.C. §119 from U.S. Provisional Application Ser. No. 60/841,856 (filed Sep. 1, 2006), the disclosure of which is incorporated by reference herein for all purposes as if fully set forth.

### FIELD OF INVENTION

The present invention is directed to a method for producing a repair estimate and scheduling for repairing a vehicle having one or more defects using a portable computing device. The invention is also directed to a system for producing such estimate and scheduling.

### BACKGROUND OF INVENTION

Providing an accurate repair estimate for repairing one or more defects on a vehicle of a customer is important and challenging. Accurate repair cost estimate is important to the repair business. Too high an estimate may turn away a customer while too low one may not cover the actual cost. Many regulatory authorities impose regulations on auto repair cost to ensure that the final cost may not exceed certain percentage, such as no more than 110% of an estimate. It is also necessary to provide such accurate estimates on a timely basis in order to permit the customer to make a selection on whether or not to repair the defects. Traditionally, an inspector from a vehicle repair shop takes notes while inspecting the vehicle in a parking lot, an inspection Bay, or other space where the vehicle is parked for locations, nature and levels of damages or defects of the vehicle. Then the inspector goes to a separate space such as an office area and utilizes reference materials, such as price lists, manuals, handbooks or online databases to identify list prices for repairing each of the inspected damages or defects. For a vehicle with multiple damages or defects of different nature, such as coating defects, interior damages, or glass damages, the inspector has to locate right reference materials or databases by expending significant amount of time and efforts. Since different vehicle may require different repairing process, repairing material or optionally repair labor, the inspector needs to generate information that is vehicle specific for coming up with an accurate repair estimate. The inspector then needs to calculate the total auto repair cost manually. Such traditional method is laborious and time consuming and often leads to inaccurate estimates. In addition, since inspection and calculation of costs occurs at separate areas, it often leads to omission or misjudgment of some defects.

Once the repair estimate is generated, a repair time schedule for repairing the vehicle also needs to be generated. Traditionally, the inspector will hand over the scheduling task to another person in the vehicle repair shop who then schedules the repair on a paper or through an electronic scheduler and provide a written reminder to the customer for the scheduled repair time. Typically, it is also necessary to notify a repair group of the shop so that appropriate resources are available for repairing the vehicle at the scheduled repair time. This traditional process requires additional personnel at the vehicle repair shop and often results in delay and causes the customer to wait for a period of time.

Vehicle repair and vehicle insurance industries have developed some methods to improve vehicle repair estimate process. Most of vehicle repair shops are using pre-printed estimate forms with most common defects and damages listed. Cost for repairing each defect or damage on the list is often provided. The inspector generally makes check marks on the repair form for the listed defects and damages while inspecting a vehicle and then totals up the costs to get a total repair estimate. One major disadvantage of pre-printed forms is that it is difficult to provide specific vehicle data based on the make, model, manufacturing year or body style of the vehicle. In addition, the pre-printed forms lack the ability to have dynamic updates on vehicle data and cost change. U.S. Pat. No. 5,317,503 attempt to address the foregoing issues through an apparatus for calculating a repair cost of a damaged vehicle. The apparatus, however, requires the user to manually input vehicle data, such as make, model, body style, etc. The apparatus uses a CD-ROM as data source which lacks the ability to have dynamic update on vehicle data and cost change. Further more, the apparatus is typically positioned at a fixed location and is not suitable for mobile use during inspection and estimating process. In addition, the apparatus does not have means for scheduling the repair once the repair estimate is completed.

Therefore need exists for a method and a system that accurately estimates vehicle repairs based on specific vehicle data, damage data, and updated cost data. It is also desirable to have a mobile repair estimate system. It is further desired to have a method and a system to schedule a repair based on available time and the nature of the repair.

### STATEMENT OF INVENTION

This invention is directed to a method for producing a repair estimate for repairing one or more defects on a vehicle of a customer, said method comprising the steps of, in any workable order:
a) entering a vehicle identification number (VIN) of the vehicle into a portable computing device, wherein the portable computing device comprises an interactive input-display member, a processor and a memory member;
b) retrieving vehicle data from a first database accessible from the portable computing device based on the VIN;
c) inspecting the vehicle to obtain individual damage data of said defects;
d) entering the individual damage data into the portable computing device through the interactive input-display member;
e) retrieving individual cost data from a second database based on the individual damage data;
f) displaying the individual cost data on the interactive input-display member;
g) generating a repair selection by specifying whether each of said defects is to be repaired; and
h) generating the repair estimate from the portable computing device based on the individual damage data, the individual cost data and the repair selection.

Another aspect of this invention is directed to a system for producing a repair estimate for repairing one or more defects on a vehicle of a customer, said system comprising:

a) a portable computing device comprising an interactive input-display member, a processor and a memory member, wherein the interactive input-display member is capable of displaying and inputting data;

b) a first database accessible from the portable computing device, wherein the first database contains multiple vehicle data retrievable based on vehicle identification numbers;

c) a second database accessible from the portable computing device, wherein the second database contains repair cost data retrievable based on damage data;

d) a computing program product operatively residing in the memory member that causes the portable computing device to perform a computing process comprising the steps of, in any workable order:
i) receiving a vehicle identification number (VIN) of the vehicle;
ii) retrieving vehicle data from a first database accessible from the portable computing device based on the VIN;
iii) receiving individual damage data of said defects;
iv) retrieving individual cost data from a second database based on the individual damage data;
v) displaying the individual cost data on the interactive input-display member;
vi) receiving input for generating a repair selection specifying whether each of said defects is to be repaired; and
vii) generating the repair estimate based on the individual damage data, the individual cost data and the repair selection; and

e) optionally, one or more additional data input and/or data output members operatively coupled to the portable computing device; and

f) optionally, one or more communication members operatively coupled to the portable computing device enabling the portable computing device to communicate with one or more electronic devices through wired or wireless connections.

Yet another aspect of this invention is directed to a method for producing a repair estimate for repairing one or more defects on an article of a customer, said method comprising the steps of, in any workable order:
a) entering an article identification number (AIN) of the article into a portable computing device, wherein the portable computing device comprises an interactive input-display member, a processor and a memory member;
b) retrieving article data from a first database accessible from the portable computing device based on the AIN;
c) inspecting the article to obtain individual damage data of said defects;
d) entering the individual damage data into the portable computing device through the interactive input-display member;
e) retrieving individual cost data from a second database based on the individual damage data;
f) displaying the individual cost data on the interactive input-display member;
g) generating a repair selection by specifying whether each of said defects is to be repaired; and
h) generating the repair estimate from the portable computing device based on the individual damage data, the individual cost data and the repair selection.

Yet another aspect of this invention is directed to a system for producing a repair estimate for repairing one or more defects on an article of a customer, said system comprising:

a) a portable computing device comprising an interactive input-display member, a processor and a memory member, wherein the interactive input-display member is capable of displaying and inputting data;

b) a first database accessible from the portable computing device, wherein the first database contains multiple article data retrievable based on article identification numbers;

c) a second database accessible from the portable computing device, wherein the second database contains repair cost data retrievable based on damage data;

d) a computing program product operatively residing in the memory member that causes the portable computing device to perform a computing process comprising the steps of, in any workable order:
i) receiving an article identification number (AIN) of the article;
ii) retrieving article data from a first database accessible from the portable computing device based on the AIN;
iii) receiving individual damage data of said defects;
iv) retrieving individual cost data from a second database based on the individual damage data;
v) displaying the individual cost data on the interactive input-display member;
vi) receiving input for generating a repair selection specifying whether each of said defects is to be repaired; and
vii) generating the repair estimate based on the individual damage data, the individual cost data and the repair selection; and

e) optionally, one or more additional data input and/or data output members operatively coupled to the portable computing device; and

f) optionally, one or more communication members operatively coupled to the portable computing device enabling the portable computing device to communicate with one or more electronic devices through wired or wireless connections.

### BRIEF DESCRIPTION OF DRAWING

FIG. 1 represents a flowchart that broadly illustrates the steps taking place in an embodiment of the method of the present invention.

FIG. 2 is a representation of a graphic user interface screen for entering vehicle identification number (VIN).

FIG. 3 is a representation of a graphic user interface screen for entering data of the customer. Soft key pad is shown on the interface screen that can be used to tap in textual data of the customer.

FIG. 4 shows representations of a graphic user interface screens for entering damage data on the exterior of the vehicle. A vehicle diagram can be retrieved from a database by the portable computing device based on vehicle body style identified by the VIN.

FIG. 5 is a representation of a graphic user interface screen for entering damage data on the interior of the vehicle. A vehicle diagram can be retrieved from a database by the portable computing device based on vehicle body style identified by the VIN.

FIG. 6 is a representation of a graphic user interface screen for displaying a repair cost for each of said defects and for generating a repair selection.

FIG. 7 is a representation of a graphic user interface screen for generating a repair estimate.

FIG. 8 is a representation of a graphic user interface screen for inputting additional comments and request.

FIG. 9 is a representation of a graphic user interface screen for entering the customer's signature as an approval. This portion of the user interface also shows some additional features of the invention.

FIG. 10 is a representation of an embodiment of a hardware configuration.

### DETAILED DESCRIPTION OF PREFERRED THE EMBODIMENT

The invention provides a method for producing a repair estimate and scheduling a repair time for repairing one or more defects on a vehicle of a customer. Although certain devices, steps, or user interfaces are described in detail with one or more embodiments, it is understood that those of ordinary skill in the art can make various changes and modifications to adapt to various uses and conditions. Such changes and modifications may include, but mot limited to choosing different devices, performing the steps in different sequential orders, or forming different hardware and optionally software configurations without departing from the spirit of this invention.

As used herein “vehicle” includes an automobile, such as, car, van, mini van, bus, SUV (sports utility vehicle); truck; semi truck; tractor; motorcycle; trailer; ATV (all terrain vehicle); pickup truck; heavy duty mover, such as, bulldozer, mobile crane and earth mover; airplanes; boats; ships; and other modes of transport.

As used herein “vehicle identification number” or “VIN” refers to a string of alphanumeric characters used by vehicle manufacturers to identify each vehicle. Different vehicles may have different VIN systems. VINs are currently used by all vehicle manufacturers to record relevant information about the vehicle, such as make, model, model year, site of manufacture, production sequence, etc. In most countries today, VINs are required by law. For example, the U.S. government currently requires all cars and trucks made for sale in U.S. to carry a 17-character vehicle identification number, which is made up of a combination of 17 numbers and letters. Each position in the VIN (numbered from left to right) is assigned a certain meaning which is applicable to all vehicle manufacturers, all of which is public information (Federal Register, Vol. 61, No. 111, Rules and Regulations, Page 29031-29036, Jun. 7, 1996). Once one obtains the meaning for each position and each character, the VIN code can be broken or parsed and key facts about a vehicle can be obtained. In the standardized 17-character format, the first 11 characters define particular features of the vehicle, while the last 6 characters identify the production sequence of that vehicle. Within the first 11 characters, the 10th and 11th characters, in particular, are used to identify the vehicle's model year and site of manufacture, respectively. Vehicle engine type, vehicle body style and retrain system type are identified by characters at 4th to 8th positions. Additional information can also be extracted from the VIN.

“Vehicle data” used herein include make, model, model year, vehicle body style, site of manufacture, production sequence, and other information of the vehicle that are provided by a vehicle manufacturer, which can be retrieved based on the VIN. The vehicle data also include other data, such as refinish coating formulations, instructions on repair process and materials that are developed by vehicle manufacturers, refinish coating providers, or vehicle parts suppliers. For example, some coating providers have developed vehicle refinish coating formulations for repairing vehicle coating defects and those coating formulations can be retrieved based on the VIN or a part of the VIN. The vehicle data can further include a diagram of a vehicle specific to vehicle body style that can be identified based on the VIN. The vehicle diagram can be retrieved from a database based on the vehicle body style identified by the VIN. The vehicle diagram can also be generated dynamically based on vehicle body style identified by the VIN by a computing device and stored in a temporary database. For example, if the VIN indicates that vehicle body style of the vehicle for repair is a sedan, then a diagram of a sedan is retrieved as part of the vehicle data. The database containing vehicle diagrams including the temporary database can be operatively residing in a portable computing device used for this invention or in other computer or computing device, such as a host computer operatively communicating with the portable computing device. The database containing vehicle diagrams can also be part of another database. In one embodiment, a vehicle diagram is retrieved from a database residing in the portable computing device based on vehicle body style identified by the VIN. In another embodiment, a vehicle diagram is retrieved from a database residing in a host computer based on the vehicle body style identified by the VIN.

The term “defect” or “damage” used herein refers to defects on a vehicle that are non-structural. The defects may include coating defects, dents on a vehicle body, vehicle interior surface and finish damages, glass and windshield damages, vehicle exterior surface damages, or combinations thereof. Examples of coating defects include chipped paint areas, discolorations, scratches, or small blemishes. Examples of dents may include small dings and dents on metal or plastic parts in the interior or exterior of the vehicle body. Vehicle interior surface and finish damages may include cuts and worn on interior surfaces and finishes. Glass and windshield damages may include cracks, scratches, or breakages of window glasses or windshield. Vehicle exterior surface damages may include scuffed bumpers, damages to side door panels, mirror casings, rims or other exterior parts of the vehicle. The defects may further include flaws and other visible non-structural defects of the vehicle that are caused by mechanical or chemical actions or by atmospheric conditions, e.g., hail or acid rain, or by vandalism.

The term “damage data” used herein includes a description or category description, severity, location, size and other descriptive data of a defect. The damage data is used for estimating repair costs. For example, a dent with a larger size and more severity can cost more than a dent with a smaller size and less severity. Damage dada for individual defect is referred to as “individual damage data”.

The term “customer” used herein refers to a person or persons who requests repair of the vehicle. A customer may be the owner of the vehicle or a representative or an agent of the owner. The customer may also be a person who has temporary possession or responsibility of the vehicle, such as a person who rents or leases a car, boat, or an airplane. The customer may also be an agency, a company, or an entity that has possession or responsibility of the vehicle, such as a rental car company or a bank who owns a lien of the vehicle.

The term “data of the customer” or “customer information” refers to information related to the customer. The data can include, but not limited to, a first name, variations of the first name, a preferred name, a nick name, a last name, a street address, a postal box address, a telephone number, a cell phone number, a pager number, a fax number, an e-mail address, a web address, an electronic file location, a photograph, an identification number or a code assigned to the customer for identification purposes, an account number, a credit card number, an insurance policy identification, an insurance company identification, a warranty policy identification, a warranty issuer's identification, a history of previously received services, a description of previously received services, a credit history, a credit score, a name of a representative, a note, a record, or a comment of the customer. The identification number or the code assigned to the customer can include, but not limited to, an article number, an estimate number, a purchase order (PO) number, a requisition order (RO) number, and other codes or identifications typically generated by a service provider or a repair shop during its normal course of business practice for identifying a customer. Data of the customer may include customer name, address, contact information, mileage of the vehicle, license plate number, state of vehicle registration, and other information or data describing the vehicle of the customer. Data of the customer can be typed directly into the portable computing device via a key board or interactive input-display device, such as a touch screen coupled to the portable computing device, or imported from another computing device, a host computer or another data import member.

A repair member refers to a person or a group of persons in a vehicle repair shop who performs repair work on a vehicle to be repaired. The repair member may also be a contractor, a repair vendor, an independent repair specialist who is authorized to repair the vehicle by the repair shop or by the customer. The repair member may also be a person or a group of persons authorized to repair the vehicle by other authorities. Example of such authorities include, but not limited to, insurance companies, commercial enterprises, governments or financial institutions that have financial interests, liability or other responsibility on the vehicle.

The term “portable computing device” used herein includes a laptop computer, a pocket PC, a personal digital assistant (PDA), a handheld electronic processing device, a mobile phone, a smart phone that combines the functionality of a PDA and a mobile phone, a tablet computer, a laptop computer, or any other electronic devices that can process information and data and can be carried by a person. A portable computing device can have a wired or wireless connection to a database or to another computing device. A portable computing device can be a client computer that communicates with a host computer in a multi-computer client-host system connected via a wired or wireless network including intranet and internet. A host computer is a computing device that can be connected to other computers or computing devices. In one embodiment, the portable computing device is a smart phone having mobile phone functionality that can connect to a host computer through wireless phone network. In another embodiment, the portable computing device is a pocket PC. In yet another embodiment, the portable computing device is a PDA having Wi-Fi or infrared wireless connection to another computer.

It is preferred that the portable computing device has an interactive input-display member wherein data can be displayed and entered on the same screen. One example of such an interactive input-display member can be a touch screen.

The term “repair estimate” used herein includes damage data, individual cost data for each of said defects, repair selection, and a total cost for repairing the selected defects based on the repair selection. A repair estimate may include additional items such as, a damage number that is generated by the portable computing device to identify each defect inspected. If a repair time is scheduled, the repair estimate may optionally further include the scheduled repair time. A repair estimate may further optionally include data of the customer. A repair estimate may even further include optional comments and request.

The term “memory member” or “memory” includes internal memory, random access memory (RAM), internal hard drive, memory card, removable memory card, flash memory card, writable or re-writable compact disk, compact disc Read-Only Memory (CD-ROM), or any other electromagnetic or optical devices that can be used to store and/or retrieve data. Some examples of removable or flash memory cards include USB flash memory, SD memory card, and memory stick.

The term “data input member” includes, but not limited to, a scanner, a bar code reader, a RFID (radio frequency identification device) sensor, a camera, a video camera, a memory card, a memory card reader, a hard drive, a portable hard drive, a disk drive, a compact disk drive, a cell phone, a PDA, a computer, a key board, a hand-writing recognition device, an interactive input-display device, or any other devices that can input data into a computing device or a host computer. The data input member also includes any devices, hardware or software that is necessary for operatively coupling the data input device to a computing device or a host computer.

The term “data output member” includes, but not limited to, a printer, a fax machine, a memory card, a memory card writer, a hard drive, a portable hard drive, a disk drive, a writable compact disk drive, a cell phone, a PDA, a computer, or any other devices that can output data from a computing device or a host computer. The data output member also includes any devices, hardware or software that are necessary for operatively coupling the data output device to a computing device or a host computer.

The term “communication member” includes wired or wireless communication devices that enable the portable computing device to communicate with one or more electronic devices or a host computer through wired or wireless connections. Wired communication devices include hardware couplings, splitters, connectors, cables or wires. Wireless communication devices include, but not limited to, Wi-Fi device, Bluetooth device, wide area network (WAN) wireless device, local area network (LAN) device, infrared communication device, optical data transfer device, radio transmitter and optionally receiver, wireless phone, wireless phone adaptor card, or any other devices that can transmit signals in a wide range of radio frequency including visible or invisible optical wavelengths and electromagnetic wavelengths. The communication member can also provide wired or wireless connections to couple one or more data input or data output devices to the portable computing device.

The term “cost data” or “repair cost data” for repairing a defect include actual costs on materials and labors, and profits that a repair shop earns. The cost data can also include taxes, database subscription fees, regulatory fees, such as waste disposal fees, or other fees and charges incurred for repairing the defect. Multiple levels of the cost data can be displayed based on different configurations of the embodiments of this invention. In one embodiment, the cost data is displayed as two separate cost items: 1) a sum of costs reflecting the actual costs of repair materials, labor and profits; and 2) taxes and regulatory fees and other fees and charges such as store space rental fees or local property taxes. In another embodiment, cost data is displayed as a single item that is a sum of actual costs on materials and labors, profits, taxes, regulatory fees and other fees and charges as mentioned above. In yet another embodiment, the cost data is displayed as only the actual costs of repair materials and labor, taxes, regulatory fess and other fees and charges as mentioned above. Individual cost data for each defect is retrieved based on individual damage data.

A “database” used herein refers to a collection of related information that can be searched and retrieved. The database can be a searchable electronic text document, a searchable PDF document, an Microsoft Excel® spreadsheet, an Microsoft Access® database (both supplied by Microsoft Corporation of Redmond, Wash.), an Oracle® database (supplied by Oracle Corporation of Redwood Shores, Calif.), or a Lynux database, each registered under their respective trademarks. The database can be a set of electronic documents, photographs, images, diagrams, or drawings, residing in a computer readable storage media that can be searched and retrieved. A database can be a single database or a set of related databases or a group of unrelated databases. “Related database” means that there is at least one common information element in the related databases that can be used to relate such databases. One example of the related databases can be Oracle® relational databases.

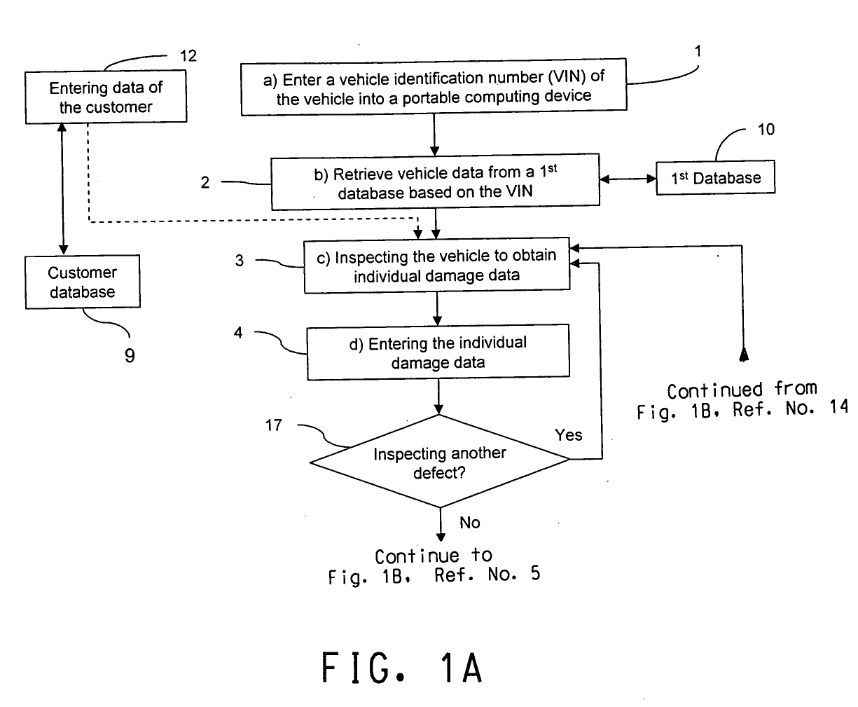

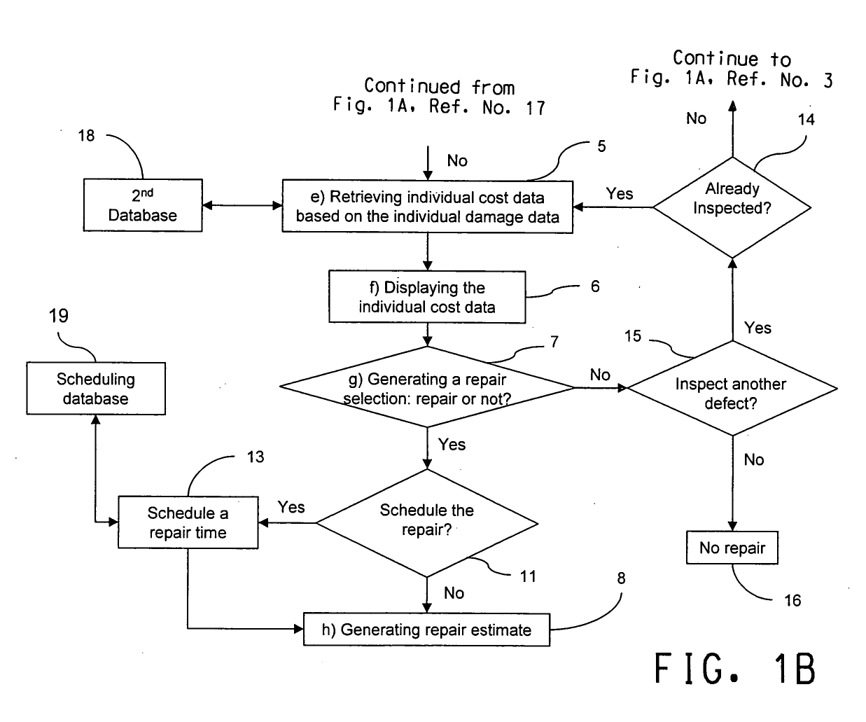

An embodiment of a workflow of this invention is presented in FIG. 1, in any workable order:
a) entering a vehicle identification number (VIN) of the vehicle into a portable computing device (1);
b) retrieving vehicle data from a first database (10) accessible from the portable computing device based on the VIN (2); Optionally, data of the customer can be entered after the step b) (12) or at any step along the workflow; and the data of the customer can be stored in and retrieved from a customer database (9);
c) inspecting the vehicle to obtain individual damage data of said defects (3);
d) entering the individual damage data into the portable computing device through the interactive input-display member (4); optionally, repeating the steps c) through d) to inspect and enter each of individual damage data for each of said defects (17);
e) retrieving individual cost data from a second database (18) based on the individual damage data (5);
f) displaying the individual cost data on the interactive input-display member (6);
g) generating a repair selection by specifying whether each of said defects is to be repaired (7):
   if the defect is to be repaired, specify it for repair and include it in the repair estimate to be generated in the step h);
   if the defect is not to be repaired, specify it for no repair and exclude it from the repair estimate;
   if the above defect is not to be repaired, then ask the question whether to inspect another defect (15), if no, then no repair will be done (16); if yes, then check whether another defect has already been inspected (14), if yes, select that additional defect; if no, repeat the step c) through g); and
Optionally, check whether to schedule a repair time (11):
   if yes, schedule the repair time (13); scheduling data can be stored in and retrieved from a scheduling database (19);
   if no, proceed to next step;
h) generating the repair estimate from the portable computing device (8).

When a vehicle repair shop receives a vehicle for repair from a customer, an inspector of the repair shop inspects the vehicle and provides a repair estimate according to the process of this invention. The following descriptions are provided for better understanding of this invention.

In step a), the inspector enters a vehicle identification number of the vehicle. The VIN can be entered by typing on a keyboard or tapping on a touch screen of a pocket PC. In one embodiment, the pocket PC also has mobile phone functionality and Wi-Fi wireless function. The VIN can also be read from the vehicle by a scanner and entered into the pocket PC via wired or wireless connection. In one embodiment, the scanner is operatively coupled to a hardware connector of the pocket PC, such as a card slot. The VIN can also be imported from previously stored vehicle data or customer data.

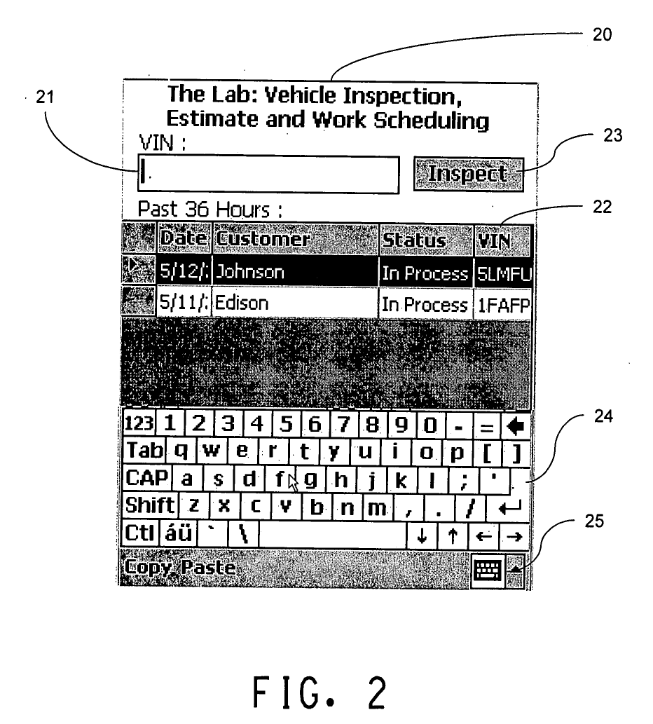

In a preferred embodiment represented by FIG. 2, the inspector can use a user interface 20 to enter the VIN into the field 21. In this preferred embodiment, soft key pad 24 was activated by tapping the icon 25 on the touch screen of the pocket PC. The VIN can also be selected from a list of previously stored VINs by tapping in the field 22.

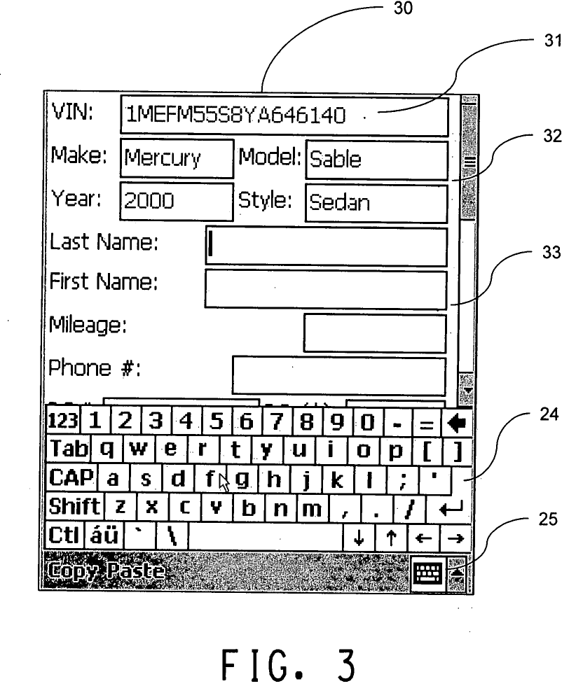

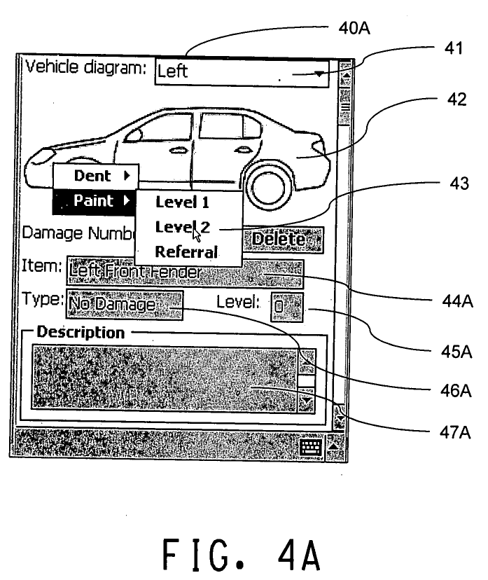

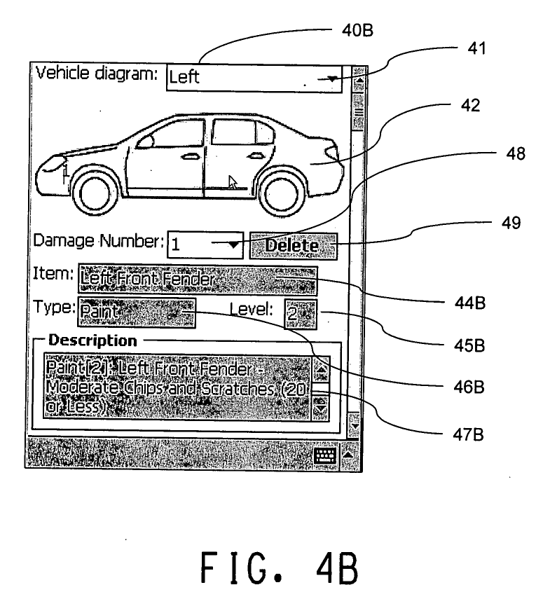

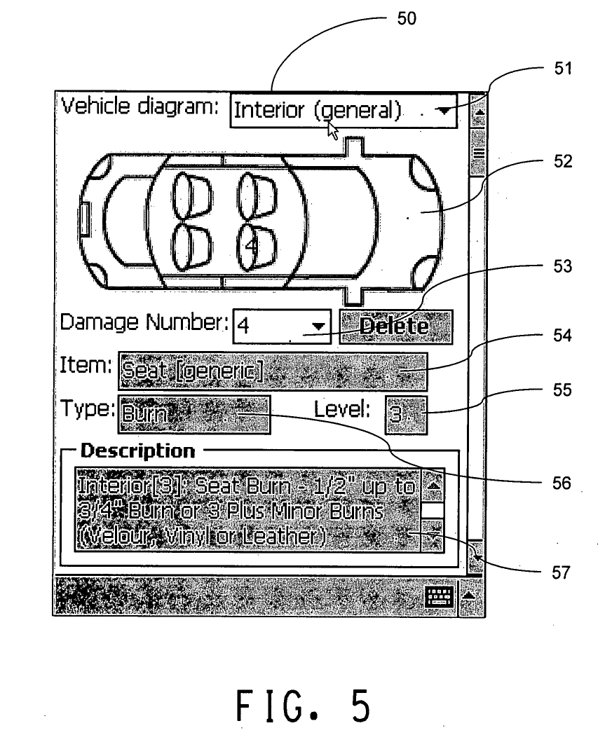

Once the VIN is entered, the inspector can tap a button 23 to move to step b), wherein the pocket PC retrieves vehicle data from a first database (10) based on the VIN. In the preferred embodiment, the first database (10) resides in a host computer (not shown) and can be accessed from the pocket PC via wireless connection (not shown). The first database can also operatively reside in internal memory, internal hard drive, or a removable memory of the pocket PC. FIG. 3 shows a representative screenshot 30 of the preferred embodiment of this invention. Vehicle data, such as make, model, year, and vehicle body style in corresponding fields in the area 32 of the touch screen can be retrieved from the first database based on the VIN. The VIN is displayed in field 31. Other vehicle data provided by vehicle manufacturer, parts suppliers, vehicle repair and refinish coating providers can also be retrieved. A diagram of the vehicle is part of the vehicle data. Based on one configuration of this invention, the diagram is shown in subsequent user interfaces, such as the ones shown in FIGS. 4 and 5. The vehicle diagram can also be generated dynamically based on vehicle body style identified by the VIN by the portable computing device and stored in a temporary database residing in the memory member of the portable computing device. A database containing vehicle diagrams, hereafter referred to as a diagram database including the temporary database, can be part or a subset of the first database (10). The diagram database can be retrieved based on vehicle body style identified by the VIN. The diagram database can reside in a memory member of the pocket PC or a computing device operatively coupled to the pocket PC, such as a host computer. The first database can be further configured to comprise refinish coating formulations so that one or more refinish coating formulations can be also retrieved based on the VIN. One example of retrieving refinish coating formulation using a VIN was described in published European patent application EP 1139234.

Data of the customer can be entered into corresponding fields in the area 33 of the user interface shown in FIG. 3 in the preferred embodiment. The data of the customer can be also imported from a list of customers stored in a customer database accessible from the pocket PC. The data of the customer can be also imported from other application program or software, such as an insurance referral program, a mailing list, a preferred customer list, a service subscriber list, a phone list, or any repair shop internal or external lists or service applications that can provide data of the customer. The data of the customer can be also entered at later time during the inspection and estimation. The data of the customer can be also left blank, if desired. It is preferred to enter the data of the customer.

In steps c) and d), the inspector inspects the vehicle to obtain individual damage data for said defects and enters the individual damage data into the portable computing device. In the preferred embodiment, the inspector can select one part of the vehicle, such as the left side, to start inspection. A corresponding diagram of the vehicle retrieved from the diagram database (part of the first database) by the pocket PC based on the vehicle body style identified by the VIN can be displayed on the touch screen (FIG. 4A). In screenshot 40A, a left side vehicle diagram 42 was selected by tapping the corresponding item in the selection drop-down list 41. The location of a defect can be entered tapping the corresponding section of the vehicle diagram. In subsequent drop-down lists 43, the damage data, such as location, type and severity of the defect can be entered into the pocket PC. In the example shown in FIG. 4A, the damage data including the location of the defect, such as “left front fender”, type of defect, such as “paint defect”, and level of defect, such as level 2, can be entered into respective fields 44A, 46A, and 45A, respectively, by selecting from appropriate drop-down list. A description can be entered in the field 47A. FIG. 4B shows a user interface screenshot 40B in that the fields 44B, 45B, 46B and 47B were filled in. A damage number was automatically generated in the field 48 to identify this damage. The damage number and associated damage data can be deleted by clicking on the button 49 in this preferred embodiment.

If more than one defect of the vehicle is to be repaired, the steps c) and d) can be repeated to inspect and input individual damage data of each of said defects. In the preferred embodiment, an additional interior defect was inspected by repeating the steps c) and d) as shown in FIG. 5. In the user interface 50, an interior general diagram was selected from the selection drop-down list 51. The diagram can be retrieved from the diagram database (part of the first database) by the pocket PC based on the vehicle body style identified by the VIN. The selected interior general diagram 52 was displayed. Details of the damage data and descriptions can be entered into corresponding fields 54, 55, 56 and 57 as shown. A Damage Number for this defect can be generated automatically by the pocket PC in the field 53.

In steps e) and f), individual cost data for repairing said defects are retrieved and displayed. The individual cost data can be retrieved from a second database 18 containing repair cost data based on the individual damage data. The second database can reside in the memory member of the portable computing device or reside in a host computer operatively connected to the portable computing device via wired or wireless connections. In the preferred embodiment, when the defect with the damage number 1 was highlighted in the defect item list 61, the defect item descriptions were displayed in the area 62 of the user interface 60. Individual cost data for repairing the defect with the damage number 1 was shown in the field 64.

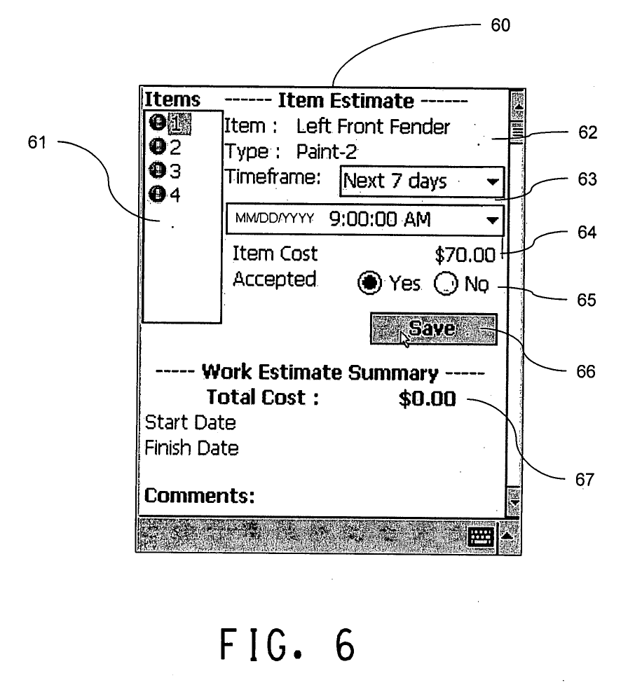

In step g), a repair selection is generated by specifying whether the first or each of the additional defects is to be repaired. In the preferred embodiment, this step can be done by checking appropriate check box or radius in the area 65 of the user interface 60 as shown in FIG. 6 wherein the radius “Yes” was checked indicating that the defect with the damage number 1 was selected for repair. The repair selection can be saved by tapping the save button 66. If the defect is not to be repaired, then the radius “No” in the area 65 is to be checked. Once the save button 66 is tapped, the defect marked with “No” will be excluded from the repair estimate that is to be generated in the step h).

It is optional to schedule a repair time for repairing the selected defect. The scheduling can be done by tapping and selecting available date and time in the fields in area 63 of the user interface 60. The fields in the area 63 can be configured to fit repair needs. In the example shown in FIG. 6, it was configured to show a timeframe, a date preferably in a format of mm/dd/yyyy where mm is a two digit designation of a month, dd is a two digit designation of day, and yyyy is a four digit designation of year, and a time of the day. If desired, the date can be shown in different format, such as dd/mm/yyyy or dd/mm/yy where yy is a two digit designation of year. In addition, a day of a week can also be displayed in the area 63. Tapping the save button 66 can also save the scheduled repair time. Data on scheduling can be stored in and retrieved from a scheduling database. The scheduling database can reside in the memory member of the portable computing device or in a host computer operatively coupled to the portable computing device via wired or wireless connections. It is preferred to have the scheduling database reside in the host computer so multiple inspectors can access the same scheduling database to schedule repair times for multiple customers or multiple repairs.

In step h), once the save button 66 is tapped, the repair estimate is automatically generated based on the saved repair selection. If a repair time is scheduled, the scheduled repair time is included in the repair estimate.

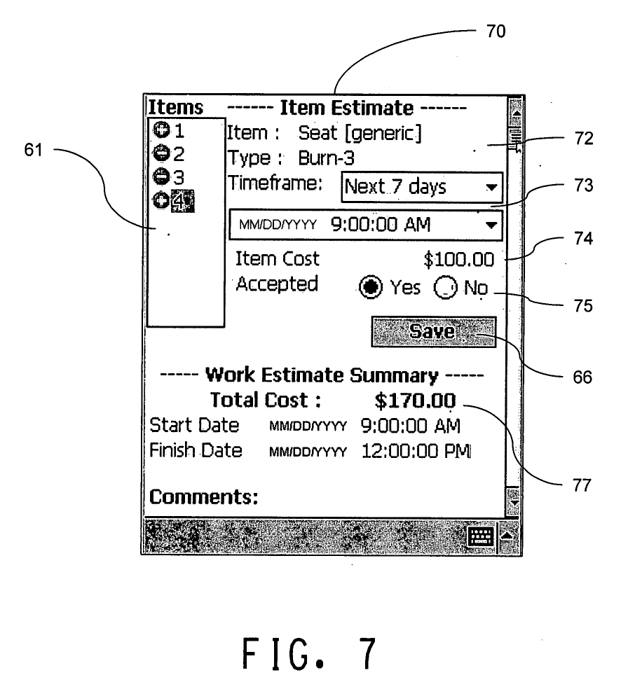

In the preferred embodiment shown in FIG. 7, multiple defects were inspected. A repair selection was generated to select only the defects with Damage Number 1 and 4. The defects with the Damage Number 2 and 3 were not selected for repair. The repair selection was displayed in the defect item list 61. In the preferred embodiment, a “+” sign designates a defect selected for repair while a “−” sign designates a defect not selected for repair. A person skilled in the art may select other designations or methods to show the repair selection. When a defect is highlighted in the defect item list 61, descriptions on that defect are displayed in the areas 72, 73, 74 and 75, respectively. A repair time can be scheduled for repairing both selected defects (73). After saving the repair selection, a repair estimate comprising a total cost estimate for repairing the selected defects can be displayed together with the scheduled repair time in the area 77. The total cost estimate is generated based on individual damage data, individual cost data and the repair selection.

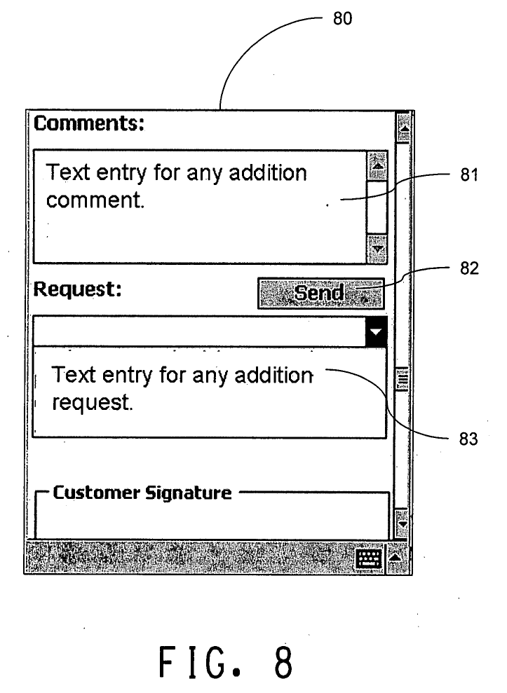

In the preferred embodiment, additional fields, such as a field for comments 81 and a field for request 83 are also provided in the user interface 80 as shown in FIG. 8. According to one configuration of the preferred embodiment, the comments 81 and the request 83 can be sent to a repair member of the repair shop as part of a repair notification. Additional information can be also included in the repair notification, such as the scheduled repair time and the repair selection. The repair member who repairs the selected defects can receive the notification in a form of e-mail, fax, print-out, or an entry in the repair member's electronic schedule. In another configuration of the preferred embodiment, information selected from the comments, the request, the repair selection, the scheduled repair time or a combination thereof, is also sent to the customer as part of the repair notification. The customer can receive the notification in a form of e-mail, fax, print-out, paper mail, a text message on a mobile phone, or a combination thereof.

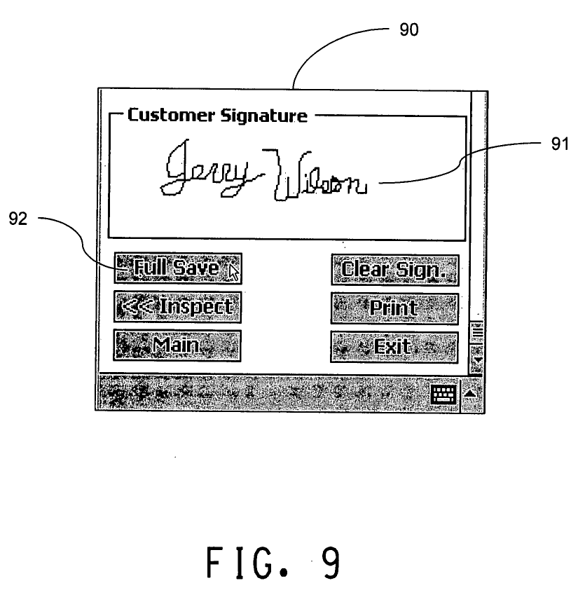

This invention can also include a functionality to obtain an approval from the customer. The approval can be in the form of an electronic signature, a signature on paper, or a vocal approval from the customer. Electronic signature is preferred. FIG. 9 shows an example of a user interface 90 where the customer can enter his or her signature 91 or an equivalent of a signature through the interactive input-display member of the portable computing device. In the preferred embodiment, the approval can be entered through the touch screen of the pocket PC. An equivalent of a signature can be a simple initial, a string of numbers or alphabets, a string of alphanumeric characters, or a combination thereof that the customer chooses to enter. The customer may also choose to enter a code through a key pad as a proof of approval. The term “electronic signature” includes the electronic signature and all aforementioned equivalents of the signature that are entered into any computing device through the interactive input-display member or any additional data input member described herein.

The repair estimate can be saved and stored in an electronic form, printed onto paper, or a combination thereof. One or more additional databases, such as customer database, scheduling database, or repair estimate database, can be operatively accessed from the portable computing device for storing and retrieving the data of the customer, the damage data, the individual cost data, the repair selection, the repair estimate, or a combination thereof. These additional databases can reside in the memory member of the portable computing device, such as internal memory, hard drive; a removable memory device, such as an SD memory card, a removable hard drive; or a combination thereof. The additional databases can also reside in a host computer that communicates with the portable computing device through wired or wireless connections.

All the databases, including the first database, the second database and the additional databases mentioned above, can be relational databases in that data in each of the relational databases can be retrieved with a common data element. For example, a customer name or phone number can be used to retrieve customer address, previous or current repair estimate, previous or current scheduling of the customer from the customer database, estimate database, and scheduling database, respectively. The retrieval can be done automatically and simultaneously through a single user interface, or performed manually in each and every database with a single or multiple user interfaces.

Although specific user interface is described above in embodiments of this invention, a person skilled in the art can modify or reconfigure the user interface without departing from the scope and the spirit of this invention.

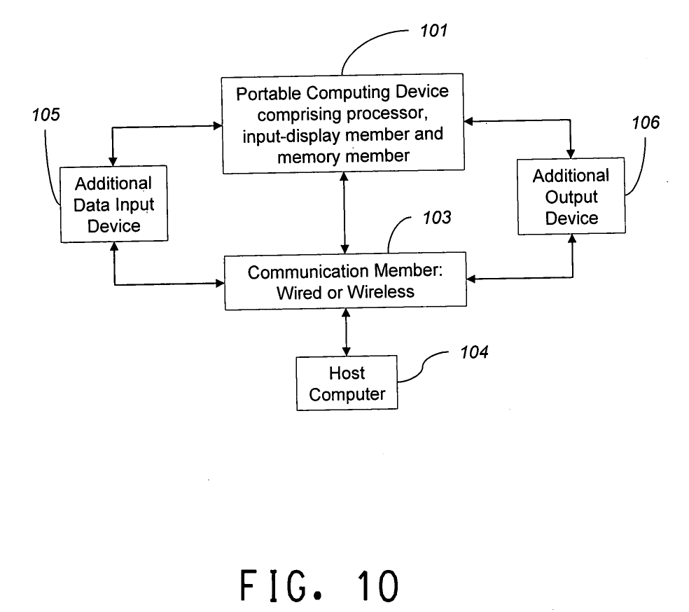

This invention is also directed to a system for producing a repair estimate for repairing one or more defects on a vehicle of a customer. An embodiment of a hardware configuration of the system is shown in FIG. 10: a portable computing device 101 comprising an interactive input-display member, a processor and a memory member, wherein the interactive input-display member, such as a touch screen, is capable of data input and data output such as displaying; optionally, one or more additional data input members 105 and, optionally, one or more additional data output members 106 operatively coupled to the portable computing device; and optionally, one or more communication members 103 operatively coupled to the portable computing device, thus enabling the portable computing device to communicate with one or more electronic devices through wired or wireless connections. The additional data input member 105 and optionally the data output member 106 can be directly coupled to the portable computing device 101, or coupled to the portable computing device through the communication member 103.

An example of the additional input member can be selected from a scanner, a bar code reader, a RFID sensor, a camera, a video camera, a memory card, a memory card reader, a hard drive, a portable hard drive, a disk drive, a compact disk drive, a cell phone, a PDA, a computer, a key board, a hand-writing recognition device, an additional interactive input-display device or touch screen, or a combination thereof. An example of additional data output member can be selected from a printer, a fax machine, a memory card, a memory card writer, a hard drive, a portable hard drive, a disk drive, a writable compact disk drive, a cell phone, a PDA, a computer, a computer monitor, a display device, or a combination thereof. A display device includes a TV screen, a projector, or any electronic device that can display information or data. In a preferred embodiment, a host computer 104 is connected to the portable computing device through the communication member through wired or wireless connections.

Although the term “vehicle” is used in aforementioned embodiments, this invention can be directed to providing a repair estimate and scheduling for repairing one or more defects on an article of a customer. The article can be a piece of furniture, a kitchen countertop, a bathroom vanity set; a household appliance, such as a refrigerator, a dishwasher, a washer and dryer, or an air conditioner; electric appliance, such as a computer, a TV set, a video player, a DVD player, or a radio set; sports equipment, such as an excise bike, a bicycle, a treadmill, a pool table, a basketball net set, a glider, or a water jet; or any other article that can be identified with an article identification number (AIN). The AIN can be a string of numbers, alphabets, or alphanumeric characters. Examples of the AIN include vehicle identification numbers (VINs), catalog numbers of commercial goods, or Universal Product Codes (UPC) or bar codes that are commonly used to code commercial goods. Article data can be available based on the AIN in databases provided by manufacturers of the article, suppliers, and retail or repair providers of the article. For example, a TV set can be identified based on its catalog number, a serial number, a manufacture UPC or bar code.

What is claimed is:

1. A method for producing a repair estimate for repairing one or more defects on a vehicle of a customer, said method comprising the steps of, in any workable order:
a) entering a vehicle identification number (VIN) of the vehicle into a portable computing device, wherein the portable computing device comprises an interactive input-display member, a processor and a memory member;
b) retrieving vehicle data from a first database accessible from the portable computing device based on the VIN;
c) inspecting the vehicle to obtain individual damage data of said defects;
d) entering the individual damage data into the portable computing device through the interactive input-display member;
e) retrieving individual cost data from a second database based on the individual damage data;
f) displaying the individual cost data on the interactive input-display member;
g) generating a repair selection by specifying whether each of said defects is to be repaired; and
h) generating the repair estimate from the portable computing device based on the individual damage data, the individual cost data and the repair selection.

2. The method of claim 1 further comprising the step of entering data of the customer.

3. The method of claim 2, wherein the repair estimate further comprises the data of the customer.

4. The method of claim 1 further comprising the step of scheduling a repair time for repairing at least one defect specified for repair in the repair selection.

5. The method of claim 4, wherein the repair estimate further comprises the repair time.

6. The method of claim 4 further comprising the step of sending a repair notification to a repair member who repairs at least one defect specified for repair in the repair selection for the customer, and optionally to the customer.

7. The method of claim 1, wherein the first database is residing in the memory member of the portable computing device, a host computer accessible from the portable computing device, or a combination thereof.

8. The method of claim 1 further comprising the step of obtaining an approval from the customer for repairing at least one defect specified for repair in the repair selection.

9. The method of claim 8, wherein the approval is an electronic signature entered into the portable computing device by the customer.

10. The method of any one of the claims 1 through 9, wherein at least one of said defects is a coating defect.

11. The method of claim 1, wherein the portable computing device is a PDA, a pocket PC, a smart phone, a handheld electronic device, a tablet computer, or a laptop computer.

12. A system for producing a repair estimate for repairing one or more defects on a vehicle of a customer, said system comprising:
a) a portable computing device comprising an interactive input-display member, a processor and a memory member, wherein the interactive input-display member is capable of displaying and inputting data;
b) a first database accessible from the portable computing device, wherein the first database contains vehicle data retrievable based on a vehicle identification number;
c) a second database accessible from the portable computing device, wherein the second database contains repair cost data retrievable based on damage data;
d) a computing program product operatively residing in the memory member that causes the portable computing device to perform a computing process comprising the steps of, in any workable order:
i) receiving a vehicle identification number (VIN) of the vehicle;
ii) retrieving vehicle data from a first database accessible from the portable computing device based on the VIN;
iii) receiving individual damage data of said defects;
iv) retrieving individual cost data from a second database based on the individual damage data;
v) displaying the individual cost data on the interactive input-display member;
vi) receiving input for generating a repair selection specifying whether each of said defects is to be repaired; and
vii) generating the repair estimate based on the individual damage data, the individual cost data and the repair selection; and
e) optionally, one or more additional data input and/or data output members operatively coupled to the portable computing device; and
f) optionally, one or more communication members operatively coupled to the portable computing device enabling the portable computing device to communicate with one or more electronic devices through wired or wireless connections.

13. The system of claim 12, wherein the one or more communication members are wireless devices selected from a Wi-Fi device, a Bluetooth device, a wide area network wireless device, a local area network device, an infrared communication device, or a combination thereof.

14. The system of claim 12, wherein the computing process further comprises the step of receiving data of the customer.

15. The system of claim 14, wherein the repair estimate further comprises the data of the customer.

16. The system of claim 12, wherein the computing process further comprises the step of scheduling a repair time for repairing at least one defect specified for repair in the repair selection.

17. The system of claim 16, wherein the repair estimate further comprises the repair time.

18. The system of claim 17, wherein the computing process further comprises the step of sending a repair notification to a repair member who repairs at least one defect specified for repair in the repair selection for the customer, and optionally to the customer.

19. The system of claim 12, wherein the computing process further comprises the step of receiving an approval from the customer for repairing at least one defect specified for repair in the repair selection.

20. The system of claim 19, wherein the approval is received as an electronic signature.

21. The system of claim 12, wherein the additional data input member is selected from a scanner, a bar code reader, a RFID sensor, a camera, a video camera, a memory card, a memory card reader, a hard drive, a portable hard drive, a disk drive, a compact disk drive, a cell phone, a PDA, a computer, a key board, a hand-writing recognition device, an interactive input-display device, or a combination thereof.

22. The system of claim 12, wherein the additional output member is selected from a printer, a fax machine, a memory card, a memory card writer, a hard drive, a portable hard drive, a disk drive, a writable compact disk drive, a cell phone, a PDA, a computer, a computer monitor, a display device, or a combination thereof.

23. The system of claim 12 further comprising additional one or more databases operatively accessible from the portable computing device for storing and retrieving the data of the customer, the damage data, the individual cost data, the repair selection, the repair estimate, scheduling, or a combination thereof.

24. The system of claim 12, wherein the memory member is an internal memory, an internal hard drive, a memory card, a removable memory card, a writable or re-writable compact disk, or a combination thereof.

25. The system of claim 12, wherein the portable computing device is a PDA, a pocket PC, a smart phone, a handheld electronic device, a tablet computer, or a laptop computer.

26. A method for producing a repair estimate for repairing one or more defects on an article of a customer, said method comprising the steps of, in any workable order:
a) entering a article identification number (AIN) of the article into a portable computing device, wherein the portable computing device comprises an interactive input-display member, a processor and a memory member;
b) retrieving article data from a first database accessible from the portable computing device based on the AIN;
c) inspecting the article to obtain individual damage data of said defects;
d) entering the individual damage data into the portable computing device through the interactive input-display member;
e) retrieving individual cost data from a second database based on the individual damage data;
f) displaying the individual cost data on the interactive input-display member;
g) generating a repair selection by specifying whether each of said defects is to be repaired; and
h) generating the repair estimate from the portable computing device based on the individual damage data, the individual cost data and the repair selection.

27. The method of claim 26 further comprising the step of entering data of the customer.

28. The method of claim 27, wherein the repair estimate further comprises the data of the customer.

29. The method of claim 26 further comprising the step of scheduling a repair time for repairing at least one defect specified for repair in the repair selection.

30. The method of claim 29, wherein the repair estimate further comprises the repair time.

31. The method of claim 30 further comprising the step of sending a repair notification to a repair member who repairs at least one defect specified for repair in the repair selection for the customer, and optionally to the customer.

32. The method of claim 26, wherein the first database is residing in the memory member of the portable computing device, a host computer accessible from the portable computing device, or a combination thereof.

33. The method of claim 26 further comprising the step of obtaining an approval from the customer for repairing at least one defect specified for repair in the repair selection.

34. The method of claim 33, wherein the approval is an electronic signature entered into the portable computing device by the customer.

35. A system for producing a repair estimate for repairing one or more defects on an article of a customer, said system comprising:
a) a portable computing device comprising an interactive input-display member, a processor and a memory member, wherein the interactive input-display member is capable of displaying and inputting data;
b) a first database accessible from the portable computing device, wherein the first database contains article data retrievable based on an article identification number;
c) a second database accessible from the portable computing device, wherein the second database contains repair cost data retrievable based on damage data;
d) a computing program product operatively residing in the memory member that causes the portable computing device to perform a computing process comprising the steps of, in any workable order:
i) receiving an article identification number (AIN) of the article;
ii) retrieving article data from a first database accessible from the portable computing device based on the AIN;
iii) receiving individual damage data of said defects;
iv) retrieving individual cost data from a second database based on the individual damage data;
v) displaying the individual cost data on the interactive input-display member;
vi) receiving input for generating a repair selection specifying whether each of said defects is to be repaired; and
vii) generating the repair estimate based on the individual damage data, the individual cost data and the repair selection; and
e) optionally, one or more additional data input and/or data output members operatively coupled to the portable computing device; and
f) optionally, one or more communication members operatively coupled to the portable computing device enabling the portable computing device to communicate with one or more electronic devices through wired or wireless connections.

36. The system of claim 35, wherein the one or more communication members are wireless devices selected from a Wi-Fi device, a Bluetooth device, a wide area network wireless device, a local area network device, an infrared communication device, or a combination thereof.

37. The system of claim 35, wherein the computing process further comprises the step of receiving data of the customer.

38. The system of claim 37, wherein the repair estimate further comprises the data of the customer.

39. The system of claim 35, wherein the computing process further comprises the step of scheduling a repair time for repairing at least one defect specified for repair in the repair selection.

40. The system of claim 39, wherein the repair estimate further comprises the repair time.

41. The system of claim 40, wherein the computing process further comprises the step of sending a repair notification to a repair member who repairs at least one defect specified for repair in the repair selection for the customer, and optionally to the customer.

42. The system of claim 35, wherein the computing process further comprises the step of receiving an approval from the customer for repairing at least one defect specified for repair in the repair selection.

43. The system of claim 42, wherein the approval is received as an electronic signature.

44. The system of claim 35, wherein the additional data input member is selected from a scanner, a bar code reader, a RFID sensor, a camera, a video camera, a memory card, a memory card reader, a hard drive, a portable hard drive, a disk drive, a compact disk drive, a cell phone, a PDA, a computer, a key board, a hand-writing recognition device, an interactive input-display device, or a combination thereof.

45. The system of claim 35, wherein the additional output member is selected from a printer, a fax machine, a memory card, a memory card writer, a hard drive, a portable hard drive, a disk drive, a writable compact disk drive, a cell phone, a PDA, a computer, a computer monitor, a display device, or a combination thereof.

46. The system of claim 35 further comprising one or more databases operatively accessible from the portable computing device for storing and retrieving the data of the customer, the damage data, the individual cost data, the repair selection, the repair estimate, scheduling, or a combination thereof.

47. The system of claim 35, wherein the memory member is an internal memory, an internal hard drive, a memory card, a removable memory card, a writable or re-writable compact disk, or a combination thereof.

48. The system of claim 35, wherein the portable computing device is a PDA, a pocket PC, a smart phone, a handheld electronic device, a tablet computer, or a laptop computer.
